(19) United States
(12) Patent Application Publication
(10) Pub. No.: US 2026/0310873 A1
(43) Pub. Date: Oct. 8, 2026

(54) DUMMY FILL LAYOUT OPTIMIZATION METHOD AND SYSTEM

(71) Applicant: Samsung Electronics Co., Ltd., Suwon-si (KR)

(72) Inventors: Jihye Lee, Suwon-si (KR); Minchul Park, Suwon-si (KR); Younggu Kim, Suwon-si (KR); Seongryeol Kim, Suwon-si (KR)

(21) Appl. No.: 19/568,139

(22) Filed: Mar. 16, 2026

(30) Foreign Application Priority Data
Apr. 2, 2025 (KR) 10-2025-0043122
Sep. 3, 2025 (KR) 10-2025-0125241

(51) Int. Cl. G06F 30/392; G06F 30/398; G06F 111/04; G06F 111/08; G06F 111/10; G06F 111/20; G06F 119/08; G06F 119/14

(52) U.S. Cl. CPC G06F 30/392; G06F 30/398; G06F 2111/04; G06F 2111/08; G06F 2111/10; G06F 2111/20; G06F 2119/08; G06F 2119/14

(57) ABSTRACT

A dummy fill layout optimization method includes generating dummy fill candidate patterns corresponding to a target layout, based on data input from a database, predicting a physical property of a layout including the dummy fill candidate patterns, and searching for an optimal dummy fill layout corresponding to the target layout, based on the predicted physical property.

### CROSS-REFERENCE TO RELATED APPLICATIONS

This application is based on and claims priority under 35 U.S.C. § 119 to Korean Patent Application Nos. 10-2025-0043122, filed on Apr. 2, 2025, and 10-2025-0125241, filed on Sep. 3, 2025, in the Korean Intellectual Property Office, the disclosures of which are incorporated by reference herein in their entirety.

### BACKGROUND

An operation of inserting a dummy fill may be performed for alleviating problems of topography occurring in a chemical mechanical polishing (CMP) process, thermal stress caused by heat, and process-induced stress, which occur when performing a semiconductor process. The placement of dummy fills may be performed using rule-based or simple techniques.

### SUMMARY

The present disclosure relates to a semiconductor design and manufacturing technology, and more particularly, to a method and system for dummy fill layout optimization in consideration of problems of chemical mechanical polishing (CMP) topography, heat, and stress.

Aspects of the present disclosure provide a dummy fill layout optimization method based on a spatial interaction.

A method of optimizing a dummy fill layout, according to an implementation, may be described.

A dummy fill layout optimization method according to an implementation includes generating one or more dummy fill candidate patterns corresponding to a target layout, based on data input from a database, predicting a physical property of a layout including the one or more dummy fill candidate patterns, and searching for an optimal dummy fill layout corresponding to the target layout, based on the predicted physical property.

A method of optimizing a dummy fill layout, according to an implementation, may be described.

A dummy fill layout optimization method according to an implementation includes performing a first training operation based on data stored in a first database and generating one or more dummy fill candidate patterns corresponding to an assigned condition, performing a second training operation based on the data stored in the first database and data stored in a second database and performing physical property evaluation on layout data including the dummy fill candidate patterns, searching for an optimal dummy fill candidate pattern corresponding to a target layout, and applying a result of the search to a design guide.

A system for optimizing a dummy fill layout, according to an implementation, may be described.

A dummy fill layout optimization system according to an implementation includes a database configured to store training data, a dummy fill searcher configured to perform a training operation based on the training data, generate one or more dummy fill candidate patterns, and based on a predicted physical property, search for an optimal dummy fill candidate pattern corresponding to a target layout, and a design guide generator configured to generate a deign guide using the optimal dummy fill candidate pattern.

### BRIEF DESCRIPTION OF THE DRAWINGS

Implementations will be more clearly understood from the following detailed description taken in conjunction with the accompanying drawings in which:

FIG. 1 is a flowchart for describing a dummy fill layout optimization method according to an implementation;

FIG. 2 is a flowchart for describing a dummy fill layout optimization method according to an implementation;

FIG. 3 is a flowchart for describing a dummy fill layout optimization method according to an implementation;

FIG. 4 is a block diagram for describing a dummy fill layout optimization system according to an implementation;

FIG. 5 is a block diagram for describing a dummy fill layout optimization system according to an implementation;

FIG. 6 is a diagram for describing an operation of a dummy fill layout optimization system according to an implementation;

FIG. 7 is a diagram for describing layout data and a method of converting the same, according to an implementation;

FIG. 8 is a diagram for describing an example of operation of a layout encoder according to an implementation;

FIGS. 9 to 11 are diagrams for describing a method of searching for and selecting a dummy fill pattern, according to an implementation;

FIG. 12 is a block diagram illustrating a computer system according to an implementation; and

FIG. 13 is a block diagram illustrating a system according to an implementation.

### DETAILED DESCRIPTION

Hereinafter, various implementations will be described in detail with reference to the accompanying drawings.

As discussed above, the placement of dummy fills may be performed using rule-based or simple techniques. However, such approaches may be limited in that they do not sufficiently take into account spatial interactions occurring in a layout. Aspects of the present disclosure may address this issue in the related art.

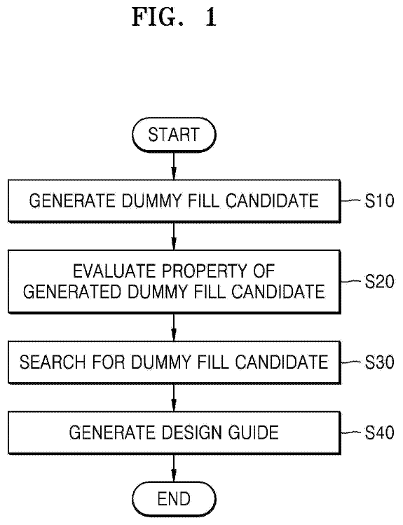

FIG. 1 is a flowchart for describing a dummy fill layout optimization method according to an implementation.

Referring to operation S10, a dummy fill candidate may be generated. Herein, a dummy fill may denote a metal pattern which is provided for increasing a density of a pattern in a layout. Also, a dummy fill may denote a metal pattern which does not perform a substantive function in a layout. The term “dummy fill” and the term “dummy fill pattern” may be used in common with each other. In operation S10, candidates of the dummy fill may be variously generated. The candidates of the dummy fill generated in operation S10 may be formed by various combinations of the number, shapes, and placement positions of patterns.

Referring to operation S20, a property of the generated dummy fill candidate may be evaluated. According to an implementation, a physical property of an entire layout including the dummy fill candidates which are generated in operation S10 may be evaluated. Here, the physical property may include one of chemical mechanical polishing (CMP) topography, a thermal property, and thermal stress in a process to which a corresponding layout is applied, but is not limited thereto.

Referring to operation S30, the dummy fill candidate may be searched. Herein, the search of the dummy fill candidate may denote a process of detecting a dummy fill having an optimal result value. The optimal result value may denote a case where a physical property value is best (minimized), but is not limited thereto.

Referring to operation S40, a design guide may be generated. According to an implementation, a guide including a design guideline associated with the placement of the dummy fill may be generated by applying data of an optimal dummy fill which is determined in operations S10 to S30. Subsequently, a user may easily place a dummy fill with reference to a corresponding design guide.

In an implementation, the dummy fill candidate may be variously generated, and a property evaluation thereof may be performed, and based thereon, the search of a dummy fill candidate may be performed. Therefore, comparing with a comparative example which places a dummy fill using rule-based, dummy fill optimization based on various physical properties and layout structures may be implemented. Accordingly, a design time may be shortened, and the cost may be reduced.

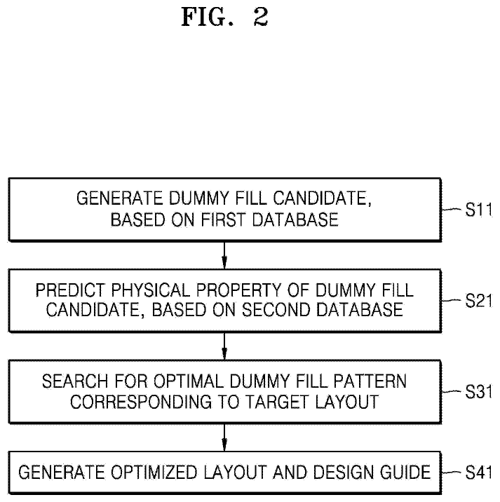

FIG. 2 is a flowchart for describing a dummy fill layout optimization method according to an implementation.

Operation S11 of FIG. 2 may be included in operation S10 of FIG. 1. Referring to operation S11, the dummy fill candidate may be generated based on a first database. The first database may denote a database including information about a layout. The first database may include structural information such as a shape, a placement position, a line width, and a space size of a pattern included in the layout. According to an implementation, in operation S11, various dummy fill candidates corresponding to an active pattern may be generated by learning a structure relationship between a dummy fill pattern and the active pattern each included in the first database. Herein, the active pattern may denote a pattern for performing a certain function. According to an implementation, the active pattern may denote a pattern, provided for performing a certain function in a device, such as a signal pattern and a power pattern. The layout data may include the active pattern and the dummy fill pattern, and the active pattern and the dummy fill pattern may be distinguished from each other, based on a pattern performing a certain function or a pattern which does not perform a substantive function.

Operation S21 of FIG. 2 may be included in operation S20 of FIG. 1. Referring to operation S21, a physical property of the layout data including the dummy fill candidate may be predicted based on a second database. The second database may be a database including result data values in a semiconductor process. According to an implementation, information included in the second database may be a physical property value which is actually measured in a semiconductor manufacturing process. According to another implementation, the information included in the second database may be a data value which is calculated through a process simulation. That is, the information included in the second database may denote real process data associated with a process of generating a circuit including an arbitrary pattern. According to an implementation, in operation S21, a physical property corresponding to a layout structure including the dummy fill pattern may be predicted by learning result data included in the second database.

Operation S31 of FIG. 2 may be included in operation S30 of FIG. 1. Referring to operation S31, an optimal dummy fill pattern corresponding to a target layout may be searched. The target layout may denote a layout including only the active pattern except the dummy fill pattern which is to be generated. According to an implementation, the target layout may be a layout where only the active pattern is designed and placed and may not include the dummy fill pattern. The target layout may be input, and thus, when a dummy fill pattern optimized for the target layout may be searched. That is, when combined with the target layout, it is possible to explore the shapes, placement structure, and number of dummy fill patterns having a best physical property value.

Operation S41 of FIG. 2 may be included in operation S40 of FIG. 1. Referring to operation S41, an optimized layout and design guide may be generated. Based on an output result obtained in operation S31, an optimal dummy fill pattern corresponding to the input target layout may be selected, and the selected optimal dummy fill pattern may be added to a library. According to another implementation, a worst dummy fill pattern corresponding to the input target layout may be selected, and the selected worst dummy fill pattern may be added to the library. The selected dummy fill pattern may be used as a design guide subsequently, and thus, a layout of a dummy fill may be optimized.

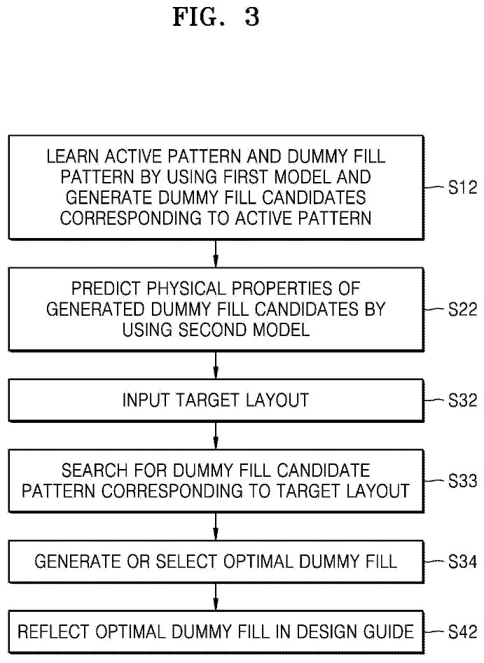

FIG. 3 is a flowchart for describing a dummy fill layout optimization method according to an implementation.

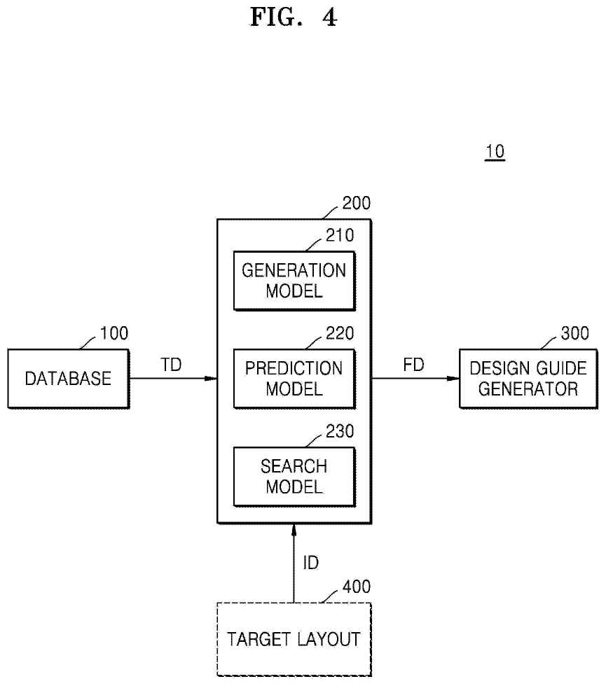

Operation S12 may be included in operation S10 of FIG. 1. Referring to operation S12, the active pattern and the dummy fill pattern may be learned by using a first model, and dummy fill candidates corresponding to the active pattern may be generated. According to an implementation, the first model may perform learning, based on the first database, and thus, the dummy fill candidates corresponding to the active pattern may be generated. The first model may include a generative artificial intelligence (AI) model, and details thereof will be described below with reference to FIG. 4.

Operation S22 may be included in operation S20 of FIG. 1. Referring to operation S22, a physical property of a layout pattern including dummy fill candidates generated by using a second model may be predicted. According to an implementation, the second model may perform learning, based on the first database and the second database. The second model may be a model which learns a physical property value based on the active pattern and the dummy fill pattern to predict the physical property of the layout pattern including the dummy fill candidate. The second model may include various learning models, and details thereof will be described below with reference to FIG. 4.

Operations S32, S33, and S34 may be included in operation S30 of FIG. 1.

Referring to operation S32, a target layout may be input. The target layout may be an input value corresponding to a condition for determining a desired dummy fill candidate. Referring to operation S33, a dummy fill candidate pattern corresponding to the target layout may be searched. A dummy fill candidate pattern search operation may be an operation of identifying a dummy fill candidate which has the best physical property value when applied to the input target layout. In corresponding operation, an operation of generating a dummy fill candidate and predicting a physical property may be repeated with reference to operations S21 and S22. Referring to operation S34, an optimal dummy fill may be generated or selected. According to an implementation, a dummy fill having an optimal result value may be selected from among dummy fills generated as dummy fill candidates, or when there is no dummy fill having the optimal result value among the dummy fills generated as the dummy fill candidates, a dummy fill pattern satisfying a condition specific for the target layout may be directly generated through a previous operation.

Operation S42 may be included in operation S40 of FIG. 1. Referring to operation S42, the optimal dummy fill may be reflected in the design guide. According to an implementation, an optimal dummy fill pattern corresponding to the target layout may be stored together, and thus, it may be possible to place an optimized dummy fill pattern subsequently.

The dummy fill layout optimization method according to an implementation may automatically generate the optimized dummy fill based on a spatial interaction, based on layout data and process property data. According to an implementation, by using a generative AI model and a virtual measurement model, a dummy fill layout based on a spatial interaction and a process property may be automatically generated and optimized, and thus, a design guide and a layout having a good physical property may be provided. According to an implementation, a dummy fill may be automatically inserted and optimized by reflecting an adjacent layout pattern and a spatial interaction property, and thus, problems of CMP topography, heat, and stress may be effectively alleviated. According to an implementation, by using a generative AI model, process stability and design efficiency may be more enhanced than the related art.

Comparing with a method based on a manual operation according to a comparative example, the dummy fill layout optimization method according to an implementation may enable faster design, and thus, may shorten a design time. Also, a design repetition operation may be reduced, and the error correction cost may be minimized, thereby decreasing the cost. By using the dummy fill layout optimization method according to an implementation, the optimization of a dummy fill pattern based on various purposes (CMP-induced defect, heat, stress, process, performance, quality, etc.) may be implemented. Also, a design margin may be quantitatively predicted, and thus, decision based on a risk of a current design may be possible.

FIG. 4 is a block diagram for describing a dummy fill layout optimization system 10 according to an implementation.

Referring to FIG. 4, the dummy fill layout optimization system 10 may include a database 100, a dummy fill pattern searcher 200, and a design guide generator 300. In the dummy fill layout optimization system 10 of FIG. 4, elements illustrated by a solid line may be elements which may be included therein, and an element illustrated by a dotted line may represent input data input thereto.

The database 100 may include pieces of data TD for learning. According to an implementation, the database 100 may include pieces of data for training at least one of a plurality of models included in the dummy fill pattern searcher 200. The database 100 may include layout data and/or pieces of process result data. The database 100 may apply the data TD for learning to the dummy fill pattern searcher 200.

The dummy fill pattern searcher 200 may include a generation model 210, a prediction model 220, and a search model 230. In an implementation, it may be described that the generation model 210, the prediction model 220, and the search model 230 are respectively provided as different elements, but the disclosure is not limited thereto and it has to be noted that some of models may be used as an integrated model.

The generation model 210 may include a generative AI model. According to an implementation, the generative AI model may perform a function of generating a new data sample from various inputs such as condition data, a random input, and noise. According to an implementation, the generative AI model may generate a text, an image, a voice, or other data format through a probabilistic operation, a deterministic operation, or a combination thereof. The generative AI model according to an implementation may be configured with a plurality of neural network layers and may learn a distribution of input data to generate various output results from an assigned condition or a random input. According to an implementation, the generation model 210 may include various generation techniques such as conditional generation, a variational autoencoder, a generative adversarial network, and a diffusion model. The generation model 210 may include a pre-trained model of various types such as a pre-trained large language model (LLM) and a multi-modal model.

The generation model 210 may receive the data TD for learning and may perform learning for generating a dummy fill pattern. According to an implementation, the generation model 210 may learn a distribution between an active pattern and the dummy fill pattern based on the data TD for learning, and may generate candidates of the dummy fill pattern corresponding to the active pattern, based on an assigned condition.

The prediction model 220 may include an artificial neural network (ANN). The ANN may denote/represent various computing systems based on a biological neural network configuring brains of an animal. In an implementation, the prediction model 220 may include a convolutional neural network (CNN). However, the ANN included in the prediction model 220 is not limited thereto and may be variously implemented. For example, the prediction model 220 may include a recurrent neural network (RNN). In implementations, the prediction model 220 may be implemented based on a long short-term memory (LSTM) technique, a gated recurrent unit (GRU) technique, and an attention technique. Unlike a classic algorithm performing an operation according to a predefined condition like rule-based programming, the ANN may learn a process of performing an operation, based on a plurality of samples (or exemplifications) (for example, pieces of input data). The ANN may have a structure where artificial neurons (or neurons) are connected to each other, and a connection between neurons may be referred to as a synapse. A neuron may process a received signal and may transfer the processed signal to another neuron through a synapse. An output of a neuron may be referred to as an activation. A neuron and/or a synapse may have a weight which may vary, and an influence of a signal processed by the neuron based on the weight may increase or decrease.

The prediction model 220 may receive the data TD for learning and may perform learning for predicting a physical property of a layout pattern including the dummy fill pattern. According to an implementation, the prediction model 220 may learn a measurement value or a process simulation value corresponding to layout data, based on the data TD for learning, and may predict a physical property value of the layout pattern including the generated dummy fill pattern.

The search model 230 may receive a target layout 400 as input data ID. The search model 230 may receive the target layout 400 and may perform a process of searching for a dummy fill pattern suitable for the target layout 400. The search model 230 may operate in a first mode or a second mode. The first mode may be a mode which variously generates candidates of a dummy fill pattern and searches for a dummy fill pattern having a good physical property among the generated candidates. The second mode may be a mode which directly generates a dummy fill pattern satisfying a predetermined certain condition. The search model 230 may determine an optimal dummy fill pattern FD by using at least one of the first mode and the second mode and may output the optimal dummy fill pattern FD to the design guide generator 300.

The design guide generator 300 may reflect the optimal dummy fill pattern FD in a design guide and may allow a user to reflect the optimal dummy fill pattern FD when designing.

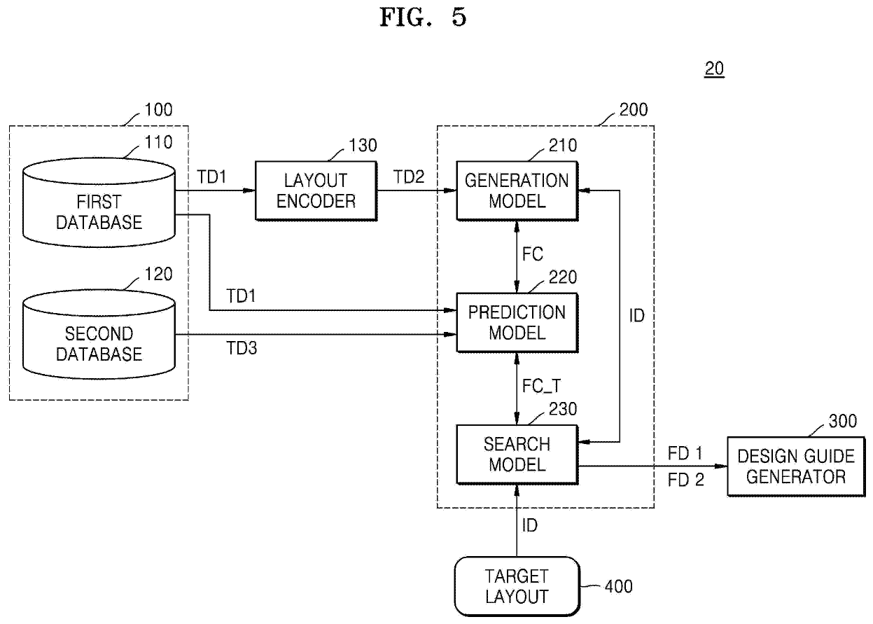

FIG. 5 is a block diagram for describing a dummy fill layout optimization system 20 according to an implementation.

In describing the dummy fill layout optimization system 20, descriptions overlapping the dummy fill layout optimization system 10 of FIG. 4 may be omitted. In elements of the dummy fill layout optimization system 20 of FIG. 5, an element having the same reference numeral as the dummy fill layout optimization system 10 of FIG. 4 may be a corresponding element, and thus, its description is omitted. The dummy fill layout optimization system 20 may further include a layout encoder 130. According to an implementation, the layout encoder 130 may be included and provided in the generation model 210.

The database 100 may include a first database 110 and a second database 120. According to an implementation, the first database 110 may include layout data which is used in a semiconductor design. Here, the layout data may refer to various pieces of design data, used for designing and manufacturing a circuit, such as placement information, a wiring pattern, an interlayer structure, mask data, and figure information each corresponding to a semiconductor device. According to an implementation, the first database 110 may include data of GDS type. According to an implementation, the first database 110 may include multi-layer structural information about a certain region (for example, 10×10 μm). The first database 110 may include information about a neighboring region as well as layout structural information such as a pattern, a line width, and a space size of a corresponding region. Therefore, a spatial interaction in a layout may be sufficiently reflected. Pieces of data included in the first database 110 may be referred to as first training data TD1.

The second database 120 may be a database which includes a physical property value measured in a real semiconductor manufacturing process or data calculated through a process simulation. The second database 120 may store a physical property value obtained through processing based on various process conditions. The second database 120 may store a physical property value obtained through a simulation instead of a real process. As an example of a physical property value stored in the second database 120, various physical property values such as CMP topography, a thermal property, and stress may be stored in the second database 120. Pieces of data included in the second database 120 may be referred to as third training data TD3.

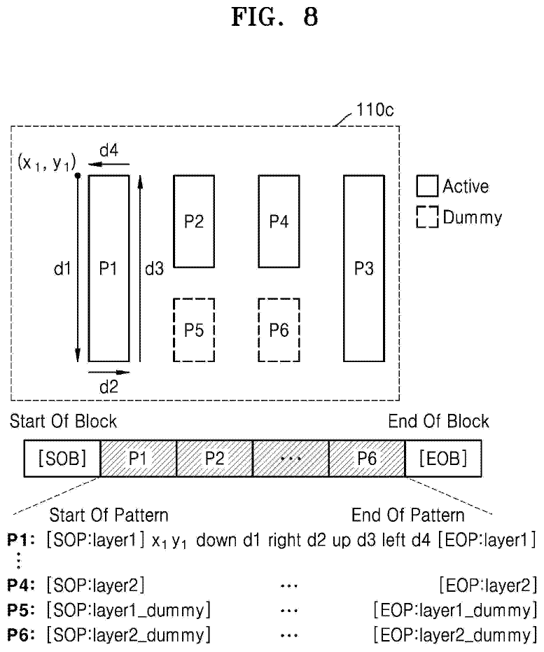

The first training data TD1 may be provided from the first database 110 to the layout encoder 130. The layout encoder 130 may output second training data TD2 which is to be input to the generation model 210. The layout encoder 130 may be a data preprocessing module which appropriately converts the applied first training data TD1 to output as the second training data TD2. That is, the first training data TD1 and the second training data TD2 may include the same information and may be pieces of data of different types. According to an implementation, the first training data TD1 may be layout data including layout elements of a polygonal type. The second training data TD2 may be character-type data obtained by converting the layout data into a token-based sequence type. When converting the first training data TD1 into the second training data TD2, the layout encoder 130 may apply a certain rule to convert data. When converting information stored in the first training data TD1, the layout encoder 130 may reorder the information so that information about an active pattern is arranged first, and information about a dummy fill pattern is arranged second. The layout encoder 130 may convert the first training data TD1 in a sequence type where the information about the active pattern and the information about the dummy fill pattern are arranged in order. This will be described below in more detail with reference to FIG. 8. The second training data TD2 may be the type of token sequence. The second training data TD2 may be input to the generation model 210. The generation model 210 may learn the second training data TD2 of a sequence type where the information about the active pattern is first described, and the information about the dummy fill pattern is second described, and thus, may generate a sequence of a dummy fill pattern of a multi-layer structure by using the information about the active pattern as an input condition.

The generation model 210 may include a generative AI model which may process a sequence of a certain length or more. The generation model 210 may include, for example, a transformer-XL language model structure, but is not limited thereto. The generation model 210 may receive the second training data TD2 which is sequence data generated by and input from the layout encoder 130 and may generate a layout sequence including a dummy fill corresponding to the information about the active pattern. The generation model 210 may generate a dummy fill candidate sequence of a multi-layer structure by using the active pattern as a condition. The generation model 210 may generate dummy fill candidate data FC corresponding to the generated layout sequence and may transfer the dummy fill candidate data FC to the prediction model 220. According to an implementation, the generated dummy fill candidate sequence may be applied to a target layout.

The prediction model 220 may receive the first training data TD1 of the first database 110 and the third training data TD3 of the second database 120. The prediction model 220 may perform learning through the first training data TD1 and the third training data TD3. The prediction model 220 may learn a distribution and a correlation between the first training data TD1 and the third training data TD3 and may predict a physical property value of a layout sequence including the dummy fill pattern. The prediction model 220 may predict a physical property such as CMP topography, a thermal property, and stress on the generated dummy fill layout. The prediction model 220 may transfer a predicted physical property value FC_T to the search model 230.

According to an implementation, the second training data TD2 for training of the generation model 210 may differ from the first and third training data TD1 and TD3 for training of the prediction model 220.

The search model 230 may receive the target layout 400 as the input data ID. The target layout 400 may be a target layout into which the dummy fill pattern is to be inserted. The target layout 400 may include real layout information including the active pattern. According to an implementation, the active pattern included in the target layout 400 may be an active pattern corresponding to a layout sequence including the dummy fill candidate sequence generated by the generation model 210, or may be a new active pattern. According to an implementation, in the first mode, the search model 230 may analyze the target layout 400, and when the active pattern included in the target layout 400 matches the active pattern corresponding to the layout sequence including the dummy fill candidate sequence generated by the generation model 210, the search model 230 may search for the generated dummy fill candidates to select a dummy fill pattern having the best property from among the generated dummy fill candidates, based on the match. According to an implementation, in the second mode, the search model 230 may analyze the target layout 400, and when the active pattern included in the target layout 400 does not match the active pattern corresponding to the layout sequence including the dummy fill candidate sequence generated by the generation model 210, the search model 230 may apply the input data ID to the generation model 210 and may perform control to predict a dummy fill candidate corresponding to corresponding input data and a property based thereon. That is, the target layout 400 may be used as a condition when generating or placing a dummy fill by using the generation model 210 and the search model 230.

The search model 230 may select or generate an optimal dummy fill through two modes. According to an implementation, the search model 230 may apply information about the first dummy fill FD1 and the second dummy fill FD2 to the design guide generator 300. According to an implementation, the first dummy fill FD1 may be an optimal dummy fill pattern corresponding to the target layout 400, and the second dummy fill FD2 may be a worst dummy fill pattern corresponding to the target layout 400. That is, the search model 230 may detect a worst dummy fill as well as detecting the optimal dummy fill and may allow the detected dummy fill to be reflected in the design guide. Accordingly, a dummy fill may be more easily designed. The search model 230 may efficiently derive an optimal dummy fill layout suitable for a process property through an optimization procedure based on the search and use and may transfer a result thereof to the design guide generator 300.

The design guide generator 300 may include a module which analyzes the optimal dummy fill layout derived by the search model 230 to provide design guide information available by a designer. The module may synthesize pattern feature analysis, a margin analysis result, and a dummy fill layout to output a synthesis result in the form of design guide, and thus, may support the designer to be used for decision in actual designing.

The dummy fill layout optimization method according to an implementation may generate a dummy fill candidate by using the layout encoder 130 and the generation model 210, based on layout data and process data, predict a physical property by using the prediction model 220, search for an optimal dummy fill pattern in the first mode or the second mode by using the search model 230, and reflect a result of the search to provide an optimized layout and design guide by using the design guide generator 300.

According to an implementation, TAT may be considerably reduced compared to a method performed based on a manual of an engineer, and a CMP topography deviation may decrease, thereby securing a stable process margin.

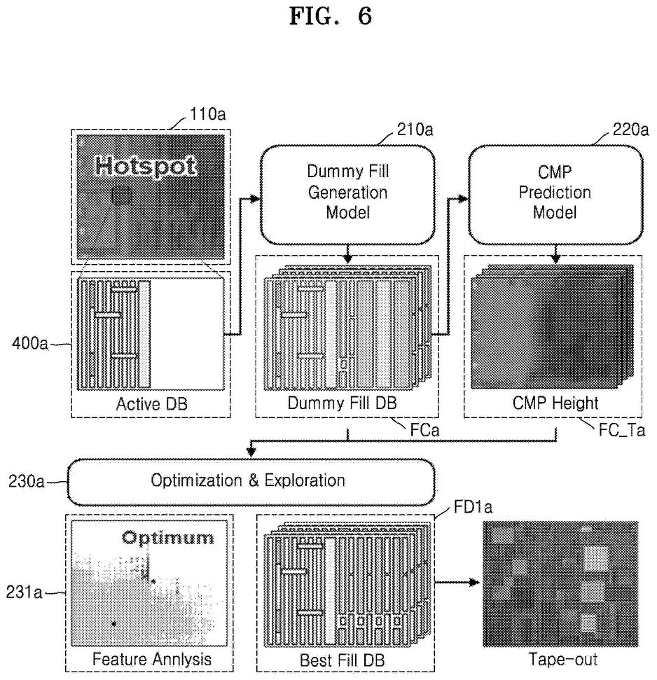

FIG. 6 is a diagram for describing an operation of a dummy fill layout optimization system according to an implementation.

Referring to FIG. 6, layout data 110a according to an implementation included in the first database 110 of FIG. 5 may be provided. The layout data 110a may include information about an entire layout pattern. The layout data 110a may include a hotspot region which is a region having a problem. According to an implementation, information about the placement of active patterns included in the hotspot region may correspond to a target layout 400a. According to an implementation, a dummy fill candidate for the active pattern included in the hotspot region may be generated.

The target layout 400a may include the shape, placement structure, and connection structure of the active patterns and may not include details of a dummy fill pattern.

According to an implementation, a dummy fill generation model 210a and a prediction model 220a may be in a state where learning is completed. According to an implementation, the dummy fill generation model 210a may generate a layout pattern FCa including dummy fill candidate patterns corresponding to the target layout 400a. The dummy fill generation model 210a may correspond to the generation model 210 described above. The dummy fill generation model 210a, as illustrated in FIG. 6, may generate dummy fill candidate patterns in the type of layout data, or may generate the dummy fill candidate patterns in the type of sequence data. Each of layout patterns FCa including dummy fill candidate patterns corresponding to the target layout 400a may include different dummy fill patterns. The prediction model 220a may perform physical property evaluation on the layout pattern FCa including the dummy fill candidate patterns corresponding to the target layout 400a. The evaluation may be performed based on a result of learning performed through input layout data into the prediction model (220a) and pieces of process data. The prediction model 220a may predict a physical property of each of the layout patterns FCa including the dummy fill candidate patterns corresponding to the target layout 400a. In FIG. 6, an implementation which predicts a CMP height as a physical property is illustrated, but this may be merely an implementation and another physical property value may be predicted. The layout pattern FCa including the dummy fill candidate patterns corresponding to the target layout 400a and a physical property value FC_Ta predicted based thereon may be input to a search model 230a. The search model 230a may compare (231a), as the type of graph, the layout pattern FCa including the dummy fill candidate patterns corresponding to the target layout 400a and the physical property value FC_Ta predicted based thereon to select a dummy fill pattern FD1a having a best physical property value. When a dummy fill pattern is selected, designing may be finished by reflecting a result of the selection.

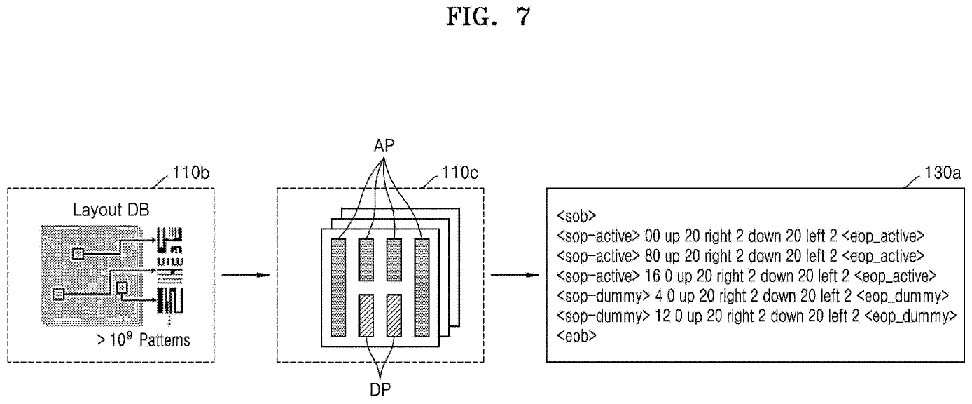

FIG. 7 is a diagram for describing layout data and a conversion method thereof, according to an implementation.

Referring to FIG. 7, layout data 110b is illustrated, and the layout data 110b may include a plurality of patterns for each layer. The layout data 110b may be converted into layout data 110c including elements of a polygonal type one-dimensionally. The converted layout data 110c may be a type including an active pattern AP and a dummy pattern DP. A layout encoder may convert the layout data 110c of a polygonal type into data 130a of a type sequenced by polygon units. An implementation which converts layout data of a polygonal type into data of a sequence type will be described below with reference to FIG. 8.

FIG. 8 is a diagram for describing an example of an operation of a layout encoder according to an implementation.

Referring to FIG. 8, the layout data 110c of polygonal type may include a first active pattern P1, a second active pattern P2, a third active pattern P3, a fourth active pattern P4, a first dummy fill pattern P5, and a second dummy fill pattern P6. According to an implementation, a certain rule may be applied for converting a plurality of active patterns and a plurality of dummy fill patterns into a sequence. When it is assumed that each of the patterns is illustrated in a block shape, a start point of a sequence may be represented by [SOB], and an end point of the sequence may be represented by [EOB]. According to an implementation, when converting layout data of FIG. 8 into a sequence, the layout data may be converted based on a rule where the active patterns P1 to P4 are arranged ahead of the dummy fill patterns P5 and P6. Referring to FIG. 8, it may be confirmed that the first active pattern P1, the second active pattern P2, the third active pattern P3, the fourth active pattern P4, the first dummy fill pattern P5, and the second dummy fill pattern P6 are arranged in order thereof, and thus, a sequence is formed.

According to an implementation, each of the first active pattern P1, the second active pattern P2, the third active pattern P3, and the first dummy fill pattern P5 may be a pattern disposed in a first layer, and each of the fourth active pattern P4 and the second dummy fill pattern P6 may be a pattern disposed in a second layer. According to an implementation, when generating a sequence, the sequence may be configured to include elements included in all layers. That is, conversion may be performed so that one sequence output includes the elements of all layers.

A method of generating a sequence corresponding to the first active pattern P1 may be described as an example. In a layer 1, a case where coordinates of a first vertex of the first active pattern P1 are (x1, y1) may be assumed. With respect to the coordinates (x1, y1) of the first vertex, the first active pattern P1 may have a length d1 in a downward direction, have a length d2 in a right direction, have a length d3 in an upward direction, and have a length d4 in a left direction. This may be expressed as a sequence type as follows.

$$[ SOP : layer 1 ] x 1 y 1 down d 1 right d 2 up d 3 left d 4 [ EOP : layer 1 ]$$

In this manner, sequence conversion may be performed on all patterns, and the patterns may be arranged in the order of active pattern-dummy fill pattern. As described above, based on a method where active patterns corresponding to a condition are arranged first, and a dummy fill pattern which is a prediction target is arranged second (e.g., after the active pattern), it may be possible to receive a first-arranged active pattern as an input and predict a dummy fill pattern. That is, a layout encoder according to an implementation may be structurized so that a dummy fill pattern is disposed after an active pattern when generating a layout sequence including the dummy fill pattern, and it is possible to generate a conditional dummy fill pattern.

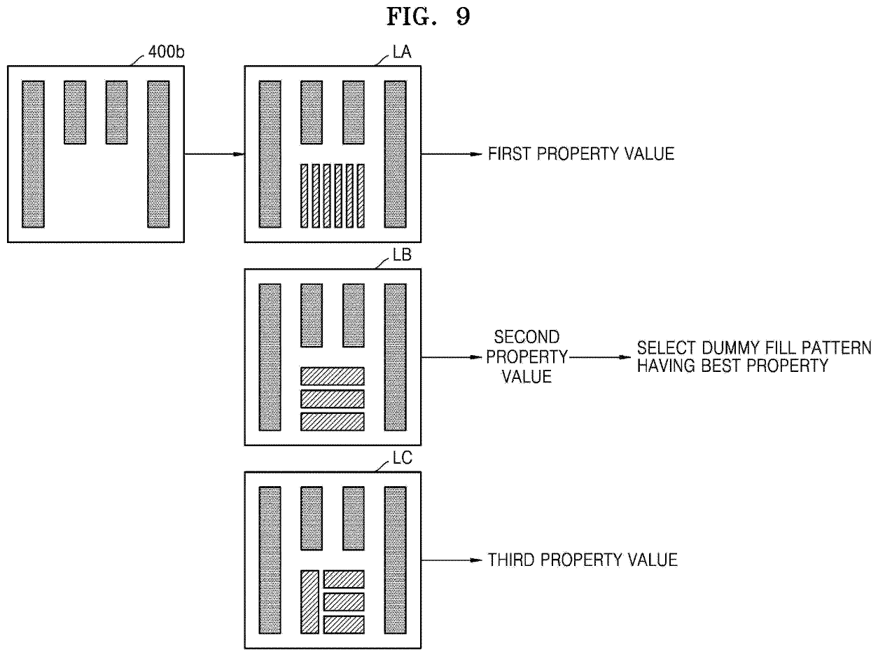

FIGS. 9 to 11 are diagrams for describing a method of searching for and selecting a dummy fill pattern, according to an implementation.

The search model 230 of FIG. 5 may search for a dummy fill layout optimized for a dummy fill pattern generated from the generation model 210. The search model 230 may perform an optimization process, based on an assigned active pattern and a predicted physical property. The search model 230 may operate in the first mode or the second mode. In the first mode, various dummy fill patterns may be generated by applying an optimization technique such as Monte Carlo simulation or simulated annealing, and a physical property of each pattern may be predicted by using the prediction model 220, and then, based thereon, a feature may be analyzed, and a pattern library may be configured. For example, in the first mode according to an implementation, the optimization technique for searching for various dummy fill candidate patterns may be applied. In detail, Monte Carlo simulation technique may generate a plurality of random sampling-based dummy fill patterns through probabilistic search and may evaluate a statistical distribution property of each pattern. In such a process, in addition to simply forming an arbitrary pattern, various dummy fill elements capable of occurring may be searched for based on different layout environments (a wiring density, a shape of an adjacent active pattern, etc.), and thus, a dummy fill candidate pattern which may represent an overall feature of a candidate pattern space may be obtained. Simulated annealing technique may model the placement of a metal filling pattern to an energy optimization issue, and thus, a dummy fill pattern which is more balanced and stabilized may be derived by a method which progressively minimizes an energy function after modeling starts in an initial arbitrary pattern. For example, search may be performed to minimize a physical cost function such as local density variation, the amount of increase in capacitance, or the non-uniformity of CMP flatness, and by using a temperature parameter which is based on a statistical probability and gradually decreases, a candidate pattern close to global optimum may be obtained while preventing the occurrence of local optimum.

As described above, in the first mode, a physical property of each of a plurality of candidate dummy fill patterns generated by the various optimization methods may be evaluated by the prediction model 220, and then, based on such prediction data, a pattern library may be constructed by performing statistical/featural analysis. The pattern library may be used as a knowledge base for inserting a customized dummy fill based on a design constraint condition in a subsequent step.

In the second mode, a constrained generation technique may be applied to induce the generation model 210 to an optimized dummy fill pattern with directly considering a constraint of an active pattern and a physical property. The constrained generation technique may include at least one of condition-based generation and loss-based generation. In detail, the condition-based generation may be a method which induces a generation model to directly reflect, as an input condition, constraint information such as a layout design rule, a distribution of active patterns, a target metal density, and an illustrated wiring interval to generate a candidate dummy fill pattern satisfying a corresponding condition. In this case, a model may internalize a corresponding condition in a generation process, and thus, an ex-post rule violation verification operation or a correction operation may be minimized, and the design suitability of a generated pattern may increase. Loss-based generation may be implemented as a method which adds a term associated with a constraint condition to a loss function. For example, the amount of increase in capacitance coupling between wires, density non-uniformity, and CMP flatness indicator of a certain region may be defined as the penalty terms of the loss function, and the generation model may be trained and optimized to minimize the loss. Therefore, the loss-based generation may calculate a dummy fill pattern which faithfully satisfies a design standard architecture and has an improved electrical⋅physical property, based on quantitative optimization-based approach.

That is, the generation model 210 may be trained and optimized to calculate a dummy fill pattern while directly reflecting a predefined constraint condition, instead of simply generating an arbitrary pattern. For example, the constraint condition may include a minimum interval factor with an active pattern, a predetermined CMP height, and electrical and mechanical reliability requirements for each certain wiring layer. The generation model may generate a candidate pattern in a state where the constraint condition is internally reflected, and thus, may directly provide an optimized dummy fill pattern within a range satisfying a design standard architecture. Accordingly, the second mode may omit or reduce a candidate search and evaluation process of the first mode, and thus, a pattern generation speed and efficiency may be enhanced, and a design rule mismatch or the necessity of an ex-post correction process may be minimized.

Referring to FIG. 9, an example which searches for a dummy fill candidate pattern in a first mode of a search model may be described according to an implementation. An example of a target layout 400b is illustrated. The target layout 400b illustrated in FIG. 9 may correspond to the target layout illustrated in FIGS. 7 and 8. Based on the target layout 400b, layout patterns LA, LB, and LC including various dummy fill patterns may be generated by applying the optimization technique such as Monte Carlo simulation or simulated annealing. Each of the generated layout patterns LA, LB, and LC including the dummy fill patterns may include dummy fill patterns having different pattern structures, placement structures, and sizes. A prediction model may predict and output a property value of each dummy fill candidate. In the first mode of the search model according to an implementation, a dummy fill candidate pattern where a property value of the prediction model is best may be selected as a dummy fill pattern having the best property.

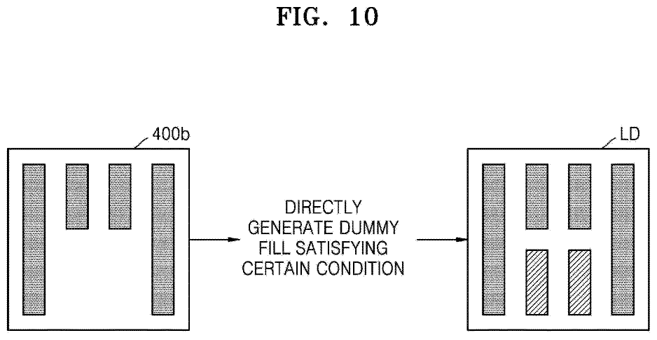

FIG. 10 illustrates an example which selects a dummy fill candidate pattern in a second mode of a search model, according to an implementation. In the second mode, unlike the first mode, the target layout 400b may be assigned instead of previously generating a dummy fill candidate pattern, and a generation model may be used to directly generate a dummy fill satisfying a certain condition. Accordingly, layout data LD including a dummy fill candidate pattern satisfying a desired physical property value may be directly generated.

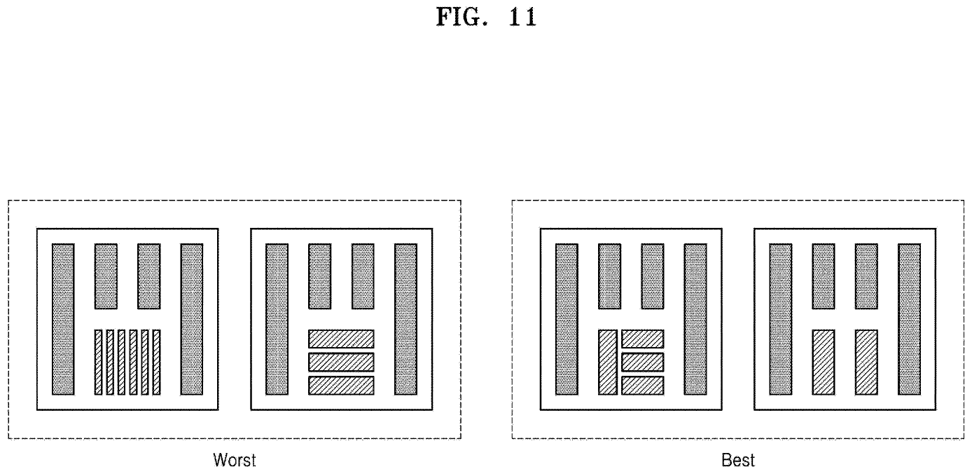

In FIG. 11, a worst case and a best case among dummy fill candidate patterns calculated through the search model may be distinguished from each other and output. A criterion for distinguishing the worst case from the best case may be determined based on whether a physical property value is greater or less than or equal to a reference value, but is not limited thereto. As described above, results of dummy fill candidate patterns may be separately stored in a library, and then, may be used as reference data when designing a layout including a similar active pattern.

According to an implementation, a sampling-selection optimization technique which couples generation candidate search to prediction evaluation may be implemented, and thus, a dummy fill pattern which minimizes a CMP variation while satisfying a design constraint condition may be generated. Also, analysis based on a feature of a sampled pattern may be performed, and then, may be used in a design methodology.

A layout optimization method according to an implementation may be used in a manufacturer which provides a semiconductor design solution and may automate a feedback loop between designing and a process to provide an optimized design to a customer, or may reinforce a customized design service specific for a process property of a certain customer. The layout optimization method according to an implementation, for example, may be used as a method of providing a correction value, so that deposition equipment or etching equipment previously analyzes an interaction and a pattern property of a certain layout, and thus, equipment performs an optimized process. The layout optimization method according to an implementation may be applied to a packaging design or three-dimensional (3D) integration technology. According to an implementation, a problem of a thermal distribution and topography occurring in a through silicon via (TSV) or a fine wiring structure may be previously predicted and providing an optimized layout, and thus, the stability of a 3D stack structure may increase.

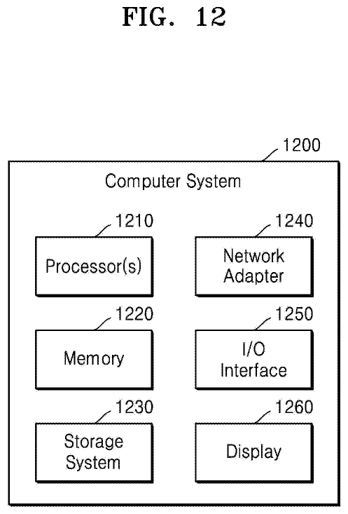

implementation FIG. 12 is a block diagram illustrating a computer system 1200 according to an implementation. In some implementations, the computer system 1200 of FIG. 12 may perform a process of the dummy fill pattern searcher 200 described above with reference to the drawings.

The computer system 1200 may refer to an arbitrary system which includes a general-purpose or special-purpose computing system. For example, the computer system 1200 may include a personal computer, a server computer, a laptop computer, and home appliances. As illustrated in FIG. 12, the computer system 1200 may include at least one processor 1210, a memory 1220, a storage system 1230, a network adapter 1240, an input/output (I/O) interface 1250, and a display 1260.

The at least one processor 1210 may execute a program module including an instruction executable by a computer system. The program module may include routines, programs, objects, components, logic, and a data structure, which performs a certain operation or implement a certain abstract data type. The memory 1220 may include a computer-readable medium, such as volatile memory (e.g., random access memory (RAM)). The at least one processor 1210 may access the memory 1220 and may execute instructions loaded into the memory 1220. The storage system 1230 may store information in a non-volatile manner and may include at least one program product including a program module configured to perform result generation and training of models for searching for an optimal dummy fill pattern described above with reference to the drawings in some implementations. In a non-transitory implementation, the programs may include an operating system, at least one application, other program modules, and program data.

The network adapter 1240 may provide access to a local area network (LAN), wide area network (WAN), and/or public network (for example, Internet). The I/O interface 1250 may provide a communication channel corresponding to a peripheral device such as a keyboard, a pointing device, or an audio system. The display 1260 may output various information so that a user checks the information.

In some implementations, the at least one processor 1210 may be implemented as a computer program product for performing a process of the dummy fill pattern searcher 200 described above with reference to the drawings. The computer program product may include a non-transitory computer-readable medium (or storage medium) including computer-readable program instructions for allowing the at least one processor 1210 to perform image processing and/or training of models. In a non-transitory implementation, the computer-readable instructions may include an assembly instruction, an instruction set architecture (ISA) instruction, a machine instruction, a machine-dependent instruction, a microcode, a firmware instruction, state setting data, or a source code or an object code written in at least one programming language.

The computer-readable medium may be a medium of arbitrary type which may non-transitorily retain and store instructions executed by the at least one processor 1210 or an arbitrary instruction-executable device. The computer-readable medium may include an electronic storage device, a magnetic storage device, an optical storage device, an electromagnetic storage device, a semiconductor storage device, or an arbitrary combination thereof, but is not limited thereto. For example, the computer-readable medium may include a mechanically encoded device like a portable computer diskette, a hard disc, RAM, read-only memory (ROM), electrically erasable read only memory (EEPROM), flash memory, static random access memory (SRAM), compact disc (CD), digital video disc (DVD), a memory stick, a floppy disc, or a punch card, or an arbitrary combination thereof.

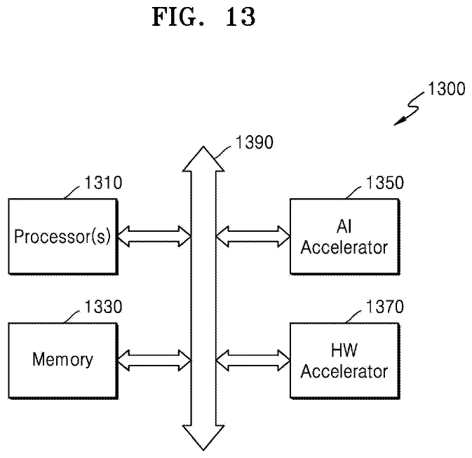

FIG. 13 is a block diagram illustrating a system 1300 according to an implementation. In some implementations, a dummy fill searcher according to an implementation may be executed in the system 1300.

Referring to FIG. 13, the system 1300 may include at least one processor 1310, a memory 1330, an artificial intelligence (AI) accelerator 1350, and a hardware accelerator 1370, and the at least one processor 1310, the memory 1330, the AI accelerator 1350, and the hardware accelerator 1370 may communicate with each other through a bus 1390. In some implementations, the at least one processor 1310, the memory 1330, the AI accelerator 1350, and the hardware accelerator 1370 may be included in one semiconductor chip. Also, in some implementations, at least two of the at least one processor 1310, the memory 1330, the AI accelerator 1350, and the hardware accelerator 1370 may be respectively included in two or more semiconductor chips mounted on a board.

The at least one processor 1310 may execute instructions. For example, the at least one processor 1310 may execute instructions stored in the memory 1330, and thus, may execute an operating system, or may execute an application executed in the operating system. In some implementations, the at least one processor 1310 may execute instructions, and thus, may instruct the AI accelerator 1350 and/or the hardware accelerator 1370 on an operation, or may obtain a performance result of the operation from the AI accelerator 1350 and/or the hardware accelerator 1370. In some implementations, the at least one processor 1310 may be an application specific instruction set processor (ASIP) customized for a certain purpose, or may support a dedicated instruction set.

The memory 1330 may have an arbitrary structure which stores data. For example, the memory 1330 may include a volatile memory device such as dynamic random access memory (DRAM) or SRAM, or may include a non-volatile memory device such as flash memory or resistive random access memory (RRAM). The at least one processor 1310, the AI accelerator 1350, and the hardware accelerator 1370 may store data in the memory 1330 or may read the data from the memory 1330 through the bus 1390.

The AI accelerator 1350 may denote hardware which is designed for AI applications. In some implementations, the AI accelerator 1350 may include a neural processing unit (NPU) for implementing a neuromorphic structure and may process input data provided from the at least one processor 1310 and/or the hardware accelerator 1370, and thus, may generate output data and may provide the output data to the at least one processor 1310 and/or the hardware accelerator 1370. In some implementations, the AI accelerator 1350 may be programmable and may be programmed by the at least one processor 1310 and/or the hardware accelerator 1370.

The hardware accelerator 1370 may denote hardware which is designed for performing a certain operation at a high speed. For example, the hardware accelerator 1370 may be designed to perform data conversion such as demodulation, modulation, encoding, and decoding at a high speed. The hardware accelerator 1370 may be programmable and may be programmed by the at least one processor 1310 and/or the hardware accelerator 1370.

In some implementations, the AI accelerator 1350 may execute the models described above with reference to the drawings. For example, the AI accelerator 1350 may execute each of the layers described above. The AI accelerator 1350 may process an input parameter and a feature map to generate an output including useful information. Also, in some implementations, at least some of models executed by the AI accelerator 1350 may be executed by the at least one processor 1310 and/or the hardware accelerator 1370.

Hereinabove, exemplary implementations have been described in the drawings and the specification. Implementations have been described by using the terms described herein, but this has been merely used for describing the disclosure and has not been used for limiting a meaning or limiting the scope of the disclosure defined in the following claims. Therefore, it may be understood by those of ordinary skill in the art that various modifications and other equivalent implementations may be implemented from the disclosure. Accordingly, the spirit and scope of the disclosure may be defined based on the spirit and scope of the following claims.

As used herein, the term “at least one of” can refer to and encompass any and all possible combinations of one or more of the associated listed terms. For example, the term “at least one of A, B, or C” means that (i) at least one of A, (ii) at least one of B, (iii) at least one of C, (iv) at least one of A and at least one of B, (v) at least one of B and at least one of C, (vi) at least one of A and at least one of C, or (vi) at least one of A, at least one of B and at least one of C are possible, where A, B and C may be singular or plural.

While the present disclosure contains many specific implementation details, these should not be construed as limitations on the scope of any invention or on the scope of what may be claimed, but rather as descriptions of features that may be specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a combination can in some cases be excised from the combination, and the combination may be directed to a subcombination or variation of a subcombination.

While the present disclosure has been particularly shown and described with reference to implementations thereof, it will be understood that various changes in form and details may be made therein without departing from the spirit and scope of the following claims.

What is claimed is:

1. A dummy fill layout optimization method comprising:
generating one or more dummy fill candidate patterns corresponding to a target layout, based on data input from a database;
predicting a physical property of a layout including the one or more dummy fill candidate patterns; and
searching for an optimal dummy fill layout corresponding to the target layout, based on the predicted physical property.

2. The dummy fill layout optimization method of claim 1, wherein generating the one or more dummy fill candidate patterns comprises converting the data input from the database into a token sequence type to perform processing thereon.

3. The dummy fill layout optimization method of claim 2, wherein converting the data into the token sequence type comprises converting the data based on a placement order of an active pattern and a dummy fill pattern.

4. The dummy fill layout optimization method of claim 3, wherein converting the data into the token sequence type comprises performing sequence conversion so that the dummy fill pattern is placed subsequent to a placement of the active pattern.

5. The dummy fill layout optimization method of claim 1, wherein the physical property of the layout comprises at least one of a chemical mechanical polishing (CMP) height, a thermal property, or a stress property.

6. The dummy fill layout optimization method of claim 1, wherein searching for the optimal dummy fill layout comprises, in a first mode, selecting a dummy fill pattern having a best property from among the one or more dummy fill candidate patterns.

7. The dummy fill layout optimization method of claim 1, wherein searching for the optimal dummy fill layout comprises, in a second mode, directly generating a dummy fill pattern satisfying the target layout and one or more conditions.

8. The dummy fill layout optimization method of claim 1, comprising storing a result, obtained based on searching for the optimal dummy fill layout, in a library and generate a design guide based on the result.

9. A dummy fill layout optimization method comprising:
performing a first training operation based on data stored in a first database and generating one or more dummy fill candidate patterns corresponding to an assigned condition;
performing a second training operation based on the data stored in the first database and data stored in a second database and performing physical property evaluation on layout data including the one or more dummy fill candidate patterns;
searching for an optimal dummy fill candidate pattern corresponding to a target layout; and
applying a result of the search to a design guide.

10. The dummy fill layout optimization method of claim 9, wherein the data stored in the first database comprises data associated with a layout, and
wherein the data stored in the second database comprises semiconductor process result data.

11. The dummy fill layout optimization method of claim 10, wherein generating the one or more dummy fill candidate patterns comprises generating the one or more dummy fill candidate based on data obtained by converting the data associated with the layout, stored in the first database, into a sequence type.

12. The dummy fill layout optimization method of claim 11, wherein the data associated with the layout comprises an active pattern and a dummy fill pattern, and
wherein converting the data associated with the layout into the sequence type comprises converting the data associated with the layout into the sequence type based on a placement order of the active pattern and the dummy fill pattern.

13. The dummy fill layout optimization method of claim 12, wherein the data associated with the layout comprises layout elements of a polygonal type, and
wherein the data converted into the sequence type is sequence data in which the active pattern is placed before the dummy fill pattern.

14. The dummy fill layout optimization method of claim 10, wherein generating the one or more dummy fill candidate patterns is performed by a generative artificial intelligence model, and
wherein the performing of the physical property evaluation on the layout data is processed by a learning model.

15. The dummy fill layout optimization method of claim 14, wherein the learning model is a model trained based on the data stored in the first database and the data stored in the second database, and the learning model is configured to predict physical properties of the one or more dummy fill candidate patterns generated by the generative artificial intelligence model.

16. The dummy fill layout optimization method of claim 10, wherein searching for the optimal dummy fill candidate pattern comprises generating a plurality of dummy fill candidate patterns based on Monte Carlo simulation, and predicting physical properties of the plurality of dummy fill candidate patterns.

17. The dummy fill layout optimization method of claim 10, wherein searching for the optimal dummy fill candidate pattern comprises performing constrained generation to directly generate a dummy fill pattern having a physical property that satisfies a predefined condition.

18. A dummy fill layout optimization system comprising:
a database configured to store training data;
a dummy fill searcher configured to:
perform a training operation based on the training data,
generate one or more dummy fill candidate patterns, and
based on a predicted physical property, search for an optimal dummy fill candidate pattern corresponding to a target layout; and
a design guide generator configured to generate a deign guide using the optimal dummy fill candidate pattern.

19. The dummy fill layout optimization system of claim 18, wherein the database comprises:
a first database configured to store data associated with a layout; and
a second database configured to store semiconductor process result data.

20. The dummy fill layout optimization system of claim 19, wherein the dummy fill searcher is configured to perform the training operation and generate the one or more dummy fill candidate patterns based on data obtained by converting the data associated with the layout, stored in the first database, into a sequence type.
